(19) United States
(12) Patent Application Publication
(10) Pub. No.: US 2008/0127459 A1
(43) Pub. Date: Jun. 5, 2008

(54) Apparatus For Gripping An Instrument Having An Elongate Handle

(76) Inventors: Paul Alan Burke, Dexter, MI (US); Gary Michael Diehl, Dexter, MI (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(21) Appl. No.: 11/566,800

(22) Filed: Dec. 5, 2006

(51) Int. Cl. B25G 1/00; A63B 53/14

(52) U.S. Cl. 16/426; 473/300

(57) ABSTRACT

A device for gripping the handle of an instrument such as a golf club or a hammer. In a preferred embodiment the device is a grip having an elongate sleeve sized to cover at least a portion of the instrument handle. A plurality of loops are disposed longitudinally along the sleeve and adapted for the insertion of at least one digit. In an alternative embodiment the instrument handle may have a plurality of apertures formed in the instrument handle and adapted for the insertion of at least one digit.

### FIELD OF THE INVENTION

The present invention relates generally to a device for gripping the handle of an instrument, and more particularly to an instrument grip having a plurality of loops or apertures to assist in maintaining control of the instrument during use.

### SUMMARY OF THE INVENTION

The present invention is directed to a grip for an instrument having a handle. The grip comprises an elongate sleeve and a plurality of loops disposed longitudinally along the sleeve. The sleeve is adapted to cover at least a portion of the handle of the instrument and the plurality of loops are adapted for the insertion of at least one digit.

Further, the invention is directed to an apparatus for preventing the unintentional release of a shafted instrument having an elongate handle. The apparatus comprises a plurality of loops disposed longitudinally along the length of the elongate handle. Each loop is adapted for the insertion of at least one digit.

Still yet, the present invention includes a golf club grip comprising an elongate sleeve attachable to a handle portion of a golf club. The elongate sleeve comprises a plurality of apertures adapted for the insertion of at least one digit into each aperture to prevent unintentional release of the golf club.

Further still, the present invention is directed to a grip for a work tool having an elongate handle. The grip comprises a plurality of apertures adapted for the insertion of at least one digit to prevent unintentional release of the work tool.

### DESCRIPTION OF THE FIGURES

FIG. 1 is a diagrammatic representation of the present invention showing a sleeve having a plurality of loops connected thereto disposed about the distal end of the handle of an instrument. The instrument of FIG. 1 may comprise a golf club handle.

FIG. 2 illustrates an alternative embodiment of the grip shown in FIG. 1 wherein the sleeve and the plurality of loops may be formed from a single piece of material.

FIG. 3 illustrates an alternative embodiment of the present invention. The embodiment of FIG. 3 has a first loop laterally offset from a plurality of loops disposed along the longitudinal axis of the handle.

FIG. 4 shows an alternative handle of the present invention having a plurality of apertures integrally formed in the handle.

### DESCRIPTION OF THE INVENTION

Many individuals having arthritis or other ailments are unable to effectively grip the handle of an instrument used in a swinging, twisting, or thrusting manner. For example, individuals having arthritis have difficulty making a tight fist and therefore have difficulty maintaining control of a golf club or hammer during the swing of either instrument. Individuals having arthritis or a similar affliction may also have difficulty maintaining control of an instrument used in a thrusting manner such as a shovel or garden trowel. As used herein, the term “instrument” means any device used by an individual in a thrusting, twisting, or swinging motion where such instrument has a generally elongate handle or shaft.

The ageing population and rise in number of people undertaking activities such as golf, fishing, and gardening has given rise to the need for instruments suitable for use by people having an infirm grip. Accordingly, several devices have been developed to help maintain a grip on and control of a golf club or shovel. However, there remains a need for improved devices to provide such individuals with a cost effective and improved alternative to previously developed devices. The present invention provides the ability to maintain improved control of a golf club or fishing rod throughout the entire swinging motion and reduces the potential for unintentional release of the instrument. The device of the present invention likewise allows the user to apply more force to an instrument used in a thrusting manner than would be normally possible when used by a person having an infirm grip.

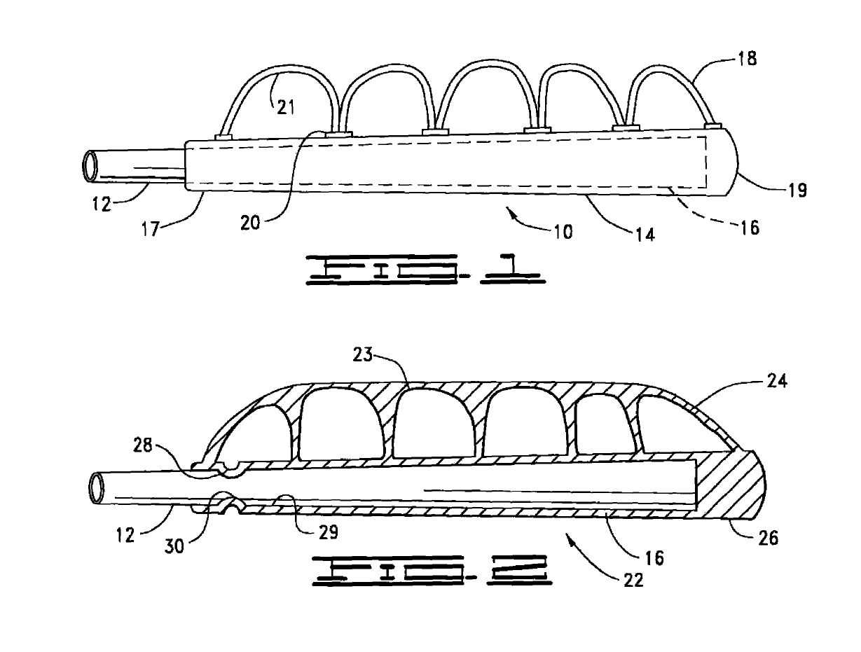

Turning now to the drawings in general and FIG. 1 in particular, there is shown therein a first embodiment of the grip of the present invention. The grip 10 is, for purposes of illustration, mounted over the end of a golf club shaft 12 in FIG. 1. The grip 10 comprises an elongate sleeve 14 adapted to cover at least a portion of a handle 16. The sleeve 14 may be tapered to have a smaller circumference at a first end 17 and a larger circumference at a second end 19. The sleeve 14 may be formed from synthetic or natural rubbers or a polyurethane material according to the preference of the user. In accordance with the present invention and as discussed with reference to FIG. 2, the sleeve 14 may be either selectively removable from the handle or permanently affixed thereto. Additionally, the sleeve may be textured in any of a wide variety of known ways to increase friction between the sleeve and the user's hand.

A plurality of loops 18 are disposed longitudinally along the sleeve 14. The loops 18 are shown in linear configuration in FIG. 1. However, one skilled in the art will appreciate that the loops 18 may be laterally offset from each other about the circumference of the sleeve 14 to fit the grip of either a left-handed or right-handed individual. The loops 18 comprise an arch 21 connected at both ends to the sleeve 14 using an epoxy or other acceptable adhesive known to those of skill in the relevant art. Alternatively, the loops 18, as shown in FIG. 2, may be integrally formed with sleeve. Each loop 18 is sized for the insertion of at least one digit and preferably may be sized to accept placement of more than one digit within a given loop.

Referring now to FIG. 2 there is illustrated an alternative grip 22 having a plurality of loops 24 disposed longitudinally along the length of sleeve 26 and integrally formed therewith. The arched portion 23 of each loop 18 may be integrally formed with its adjacent loops as shown in FIG. 2 to form a single piece. As described with reference to FIG. 1, the sleeve may be permanently attached to the handle 16 using an adhesive or epoxy. Alternatively, the sleeve 26 may comprise a protrusion 28 disposed about the inner diameter 29 of the sleeve and adapted for engagement with a circumferential notch 30 formed in the handle 16. It will be appreciated that the protrusion 28 and notch 30 arrangement may be used with any of the sleeves described herein to make such sleeve selectively removable. Alternatively, the sleeve could be attached to the handle using a sleeve having internal threads (not shown) adapted to engage a similarly threaded portion of the handle.

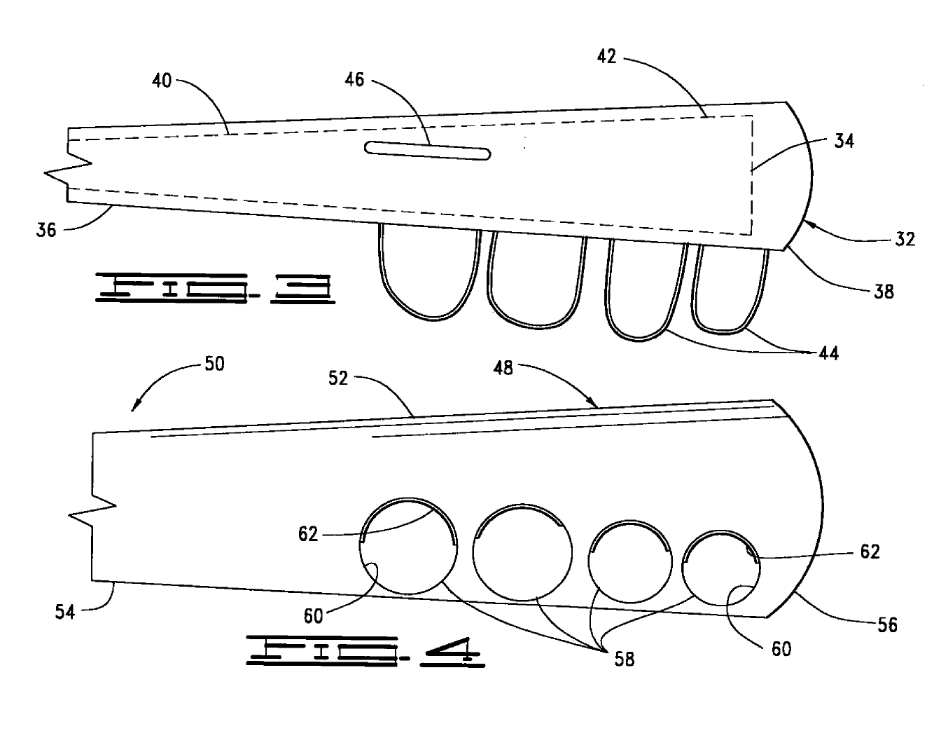

Turning now to FIG. 3, there is shown therein an alternative embodiment of the present invention. The embodiment shown in FIG. 3 comprises a handle having a plurality of loops 44 disposed longitudinally along the length of the handle. As discussed above, the loops 44 may be integrally formed with the sleeve or alternatively they may be attached to the sleeve using an adhesive or epoxy.

The apparatus shown in FIG. 3 comprises a sleeve 32 adapted to cover at least a portion of handle 34. The sleeve 32 has an increasing outer diameter from a first end 36 of the sleeve 32 to a second end 38 of the sleeve. The handle 34 shown in FIG. 3 is representative of a commonly used hammer handle and may likewise have an increasing outer diameter from a first end 40 to a second end 42. One skilled in the art would appreciate that the sleeve 32 shown in FIG. 3 may be used with alternative type that do not necessarily taper from one end to another such as an axe handle, a hatchet handle. Alternatively, the handle 34 may comprise the handle of a tool used in a thrusting motion, i.e. garden trowel or shovel, adapted to receive the sleeve 32 of the present invention.

A plurality of loops 44 are supported along the length of sleeve 32 and adapted for the insertion of at least one digit of the user therein. The sleeve in FIG. 3 preferably comprises five (5) loops 44. Four of the loops 44 are disposed on the sleeve in longitudinal alignment while a fifth loop 46 is laterally offset from the remaining four loops 44. Such an offset alignment allows for insertion of the thump into loop 46 when the handle 34 and sleeve 32 are grasped with the user right hand. It will be appreciated that loop 46 may be positioned on the opposite side of sleeve 32 for left-handed users and adjustable to fit users having different size hands and digits.

With reference now to FIG. 4 there is shown therein another alternative embodiment of the present invention. The embodiment of FIG. 4 comprises a grip 48 for a work tool 50. As discussed with reference to FIG. 3 the work tool may comprises any work tool having an elongate handle 52 and used in either a thrusting or swinging motion. The elongate handle 52 may be generally cylindrical and constructed to have an increasing outer diameter from the first end 54 of the handle to the second end of the handle 56. Of course, one skilled in the art will appreciate that the handle 52 may take many other forms or shapes within the scope of the present invention. For example, the handle 52 of the present invention may be constructed in the manner of a traditional axe handle.

Continuing with FIG. 4, the grip 48 comprises a plurality of apertures 58 formed in the handle 52 for the insertion of at least one digit within each aperture. The insertion of the user's fingers into the four (4) apertures 58 shown allows a user afflicted with arthritis or an infirm grip to swing, twist, or thrust work tool 50 with a stronger grip, greater control and a reduced likelihood that the work tool will be unintentionally released. Apertures 58 are disposed near the second end 56 of the handle 52 and opposite a work implement (not shown) connected to the first end 54 of the handle 52.

The apertures may, as illustrated in FIG. 4, be of different sizes to fit the varying size of digits on the user's hand. Additionally, the apertures, while circular in FIG. 4, may have a different geometric shape without departing from the spirit of the invention. By way of example, it may be preferred to have apertures 58 having a hexagonal shape to allow for greater control of the work tool 50. Further, the inner surface 60 of each aperture may be partially or completely covered by a commercially available texture material 62 to improve the comfort of the grip and increase friction between the user's digits and the handle. Such texture material 62 may comprise natural or synthetic rubbers adhered to the inner surface 60 of the apertures 58 or a commercially available grip tape having comfortable grit value.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that within the scope of the appended claims, the invention may be practiced otherwise than as specifically illustrated and described.

We claim:

1. A grip for an instrument having a handle, the grip comprising:
an elongate sleeve adapted to cover at least a portion of the handle of the instrument and
a plurality of loops disposed longitudinally along the sleeve, wherein the plurality of loops are adapted for the insertion of at least one digit.

2. The grip of claim 1 wherein the instrument is used in a swinging motion.

3. The grip of claim 2 wherein the instrument comprises a golf club.

4. The grip of claim 1 wherein the instrument comprises an instrument used in a thrusting motion.

5. The grip of claim 4 wherein the instrument comprises a garden tool.

6. The grip of claim 1 wherein the plurality of loops are positioned on the sleeve for a right-handed grip.

7. The grip of claim 1 wherein the sleeve is permanently disposed on the handle of the instrument.

8. The grip of claim 1 wherein the sleeve is removable from the handle.

9. The grip of claim 1 wherein each loop is sized for insertion of one digit.

10. The grip of claim 1 wherein at least a first loop is laterally offset from at least a second loop.

11. The grip of claim 1 wherein at least one of the plurality of loops is sized for the insertion of a plurality of digits.

12. An apparatus for preventing the unintentional release of a shafted instrument having an elongate handle, the apparatus comprising a plurality of loops disposed longitudinally along the length of the elongate handle wherein each loop is adapted for the insertion of at least one digit.

13. The apparatus of claim 12 wherein the plurality of loops are integrally formed with the handle of the shafted instrument.

14. The apparatus of claim 12 further comprising a sleeve adapted to cover a distal end of the handle and wherein the plurality of loops are integrally formed with the sleeve.

15. The apparatus of claim 12 further comprising at least five loops.

16. The apparatus of claim 12 wherein the instrument comprises a golf club.

17. The apparatus of claim 12 wherein the instrument comprises a garden tool.

18. The apparatus of claim 14 wherein the sleeve is selectively usable with a plurality of shafted instruments.

19. A golf club grip comprising an elongate sleeve attachable to a handle portion of a golf club, the elongate sleeve comprising a plurality of apertures adapted for the insertion of at least one digit into each aperture to prevent unintentional release of the golf club.

20. The golf club grip of claim 19 wherein the plurality of apertures are disposed on the elongate sleeve for a right-handed grip.

21. The golf club grip of claim 19 wherein the plurality of apertures are disposed on the elongate sleeve for a left-handed grip.

22. The golf club grip of claim 19 wherein the elongate sleeve is removable from the handle portion of the golf club.

23. The golf club grip of claim 19 wherein the sleeve comprises at least four apertures.

24. The golf club grip of claim 19 wherein at least a first aperture is laterally offset from at least a second aperture.

25. A grip for a work tool, the work tool having an elongate handle, the grip comprising a plurality of apertures adapted for the insertion of at least one digit to prevent unintentional release of the work tool.

26. The grip of claim 25 further comprising a sleeve adapted to cover at least a portion of the elongate handle, wherein the plurality of apertures are operatively disposed on the sleeve.

27. The grip of claim 26 wherein the plurality of apertures comprises a plurality of loops integrally formed with the sleeve.

28. The grip of claim 25 wherein the work tool comprises a hand tool.

29. The grip of claim 28 wherein the work tool is used in a swinging motion.

30. The grip of claim 29 wherein the work tool comprises a hammer.

31. The grip of claim 25 wherein the work tool is used in a thrusting motion.

32. The grip of claim 31 wherein the work tool comprises a shovel.

33. The grip of claim 26 wherein the sleeve is selectively removable from the elongate handle.

34. The grip of claim 26 wherein the sleeve is integrally formed with the elongate handle.

35. The grip of claim 25 wherein the plurality of apertures are disposed longitudinally along the elongate handle.
